(19) United States
(12) Patent Application Publication
(10) Pub. No.: US 2013/0250190 A1
(43) Pub. Date: Sep. 26, 2013

(54) BACK LIGHT UNIT INTEGRATED DIGITIZER

(71) Applicant: SAMSUNG ELECTRO-MECHANICS CO., LTD., Suwon (KR)

(72) Inventors: Dong Sik Yoo, Suwon (KR); Hee Bum Lee, Suwon (KR); Jong In Na, Suwon (KR); Ho Yun Cho, Suwon (KR); Yun Ki Hong, Suwon (KR); Kyoung Soo Chae, Suwon (KR)

(73) Assignee: SAMSUNG ELECTRO-MECHANICS CO., LTD., Suwon (KR)

(21) Appl. No.: 13/849,135

(22) Filed: Mar. 22, 2013

(30) Foreign Application Priority Data
Mar. 22, 2012 (KR) 10-2012-0029319

(51) Int. Cl. G02F 1/1333; F21V 8/00

(52) U.S. Cl. CPC G02F 1/13338; G02B 6/0011
USPC 349/12; 349/62; 362/97.1; 362/611; 362/97.2

(57) ABSTRACT

Disclosed herein is a back light unit integrated digitizer. The back light unit integrated digitizer includes a cover disposed on one surface of the back light unit to protect the back light unit; and a loop coil formed on the cover, wherein the loop coil is directly formed on the cover of the back light unit to integrally form the digitizer in the back light unit, thereby reducing the overall thickness to implement slimness and saving manufacturing costs to secure price competitiveness.

### CROSS REFERENCE TO RELATED APPLICATION

This application claims the benefit of Korean Patent Application No. 10-2012-0029319, filed on Mar. 22, 2012, entitled “Back Light Unit Integrated Digitizer” which is hereby incorporated by reference in its entirety into this application.

### BACKGROUND OF THE INVENTION

1. Technical Field

The present invention relates to a back light unit integrated digitizer.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, a digitizer has been developed as an input device capable of inputting information such as text, graphics, or the like.

Meanwhile, like Patent Document described in the following Citation List, the digitizer according to the prior art uses a sensing pad disposed under a liquid crystal display (LCD) as a sensor.

However, the digitizer according to the prior art includes the sensing pad separately from the LCD, and therefore has a thick thickness to make it difficult to slim, consumes much manufacturing costs to degrade price competitiveness, and the like.

[Prior Art Document]

[Patent Document]

(Patent Document 1) US2004-0223089 A1

### SUMMARY OF THE INVENTION

The present invention has been made in an effort to provide a back light unit integrated digitizer capable of reducing an overall thickness and saving manufacturing costs by integrally forming the digitizer in a back light unit of a liquid crystal display.

According to a preferred embodiment of the present invention, there is provided a back light unit integrated digitizer, including: a cover disposed on one surface of the back light unit to cover the back light unit; and a loop coil formed on the cover.

The loop coil may be formed in the back light unit direction in both surfaces of the cover.

The loop coil may include: a first loop coil formed on one surface of the cover; and a second loop coil formed on an insulating layer disposed on one surface of the cover.

The first loop coil and the second loop coil may intersect vertically to each other.

In the back light unit, a reflector, a housing, a light guide, and a sheet material may be stacked in order and the cover may be disposed under the reflector.

The sheet material may include a diffusion sheet, a prism sheet, and a protective sheet.

The other surface of the back light unit may be provided with a LCD panel.

The LCD panel may include a liquid crystal module (LCM) and polarizers disposed on both sides of the LCM.

A touch panel may be disposed over the LCD panel.

The touch panel may be a capacitive type touch panel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view of a back light unit integrated digitizer according to a preferred embodiment of the present invention;

FIG. 2 is an exploded perspective view of a cover illustrated in FIG. 1;

FIG. 3 is a plan view of a cover illustrated in FIG. 1;

FIG. 4 is a block diagram of a digitizer according to a preferred embodiment of the present invention; and

FIG. 5 is an exploded perspective view of a back light unit integrated digitizer according to a modified example of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

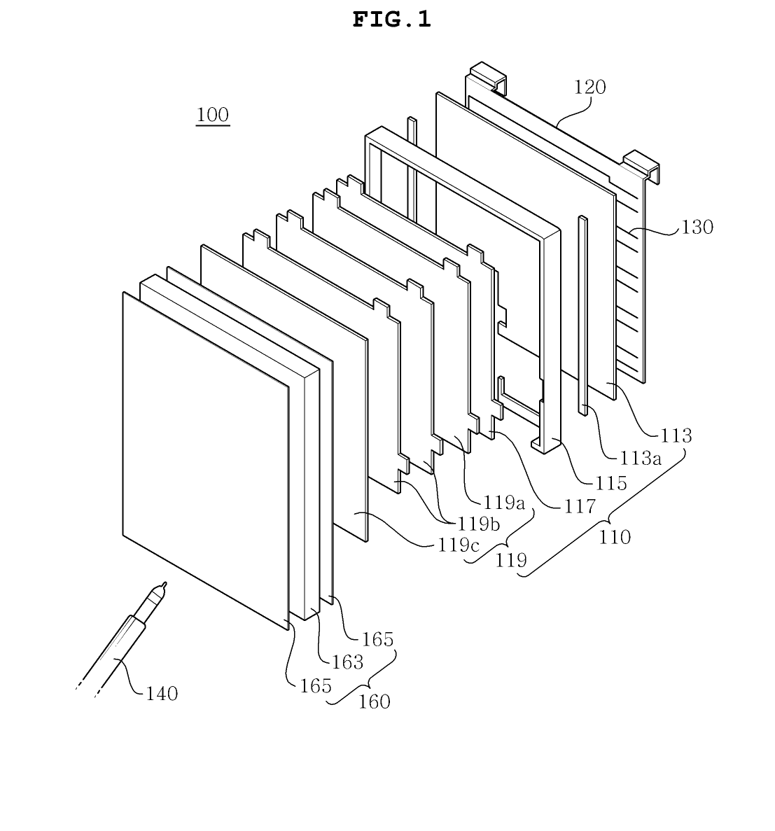

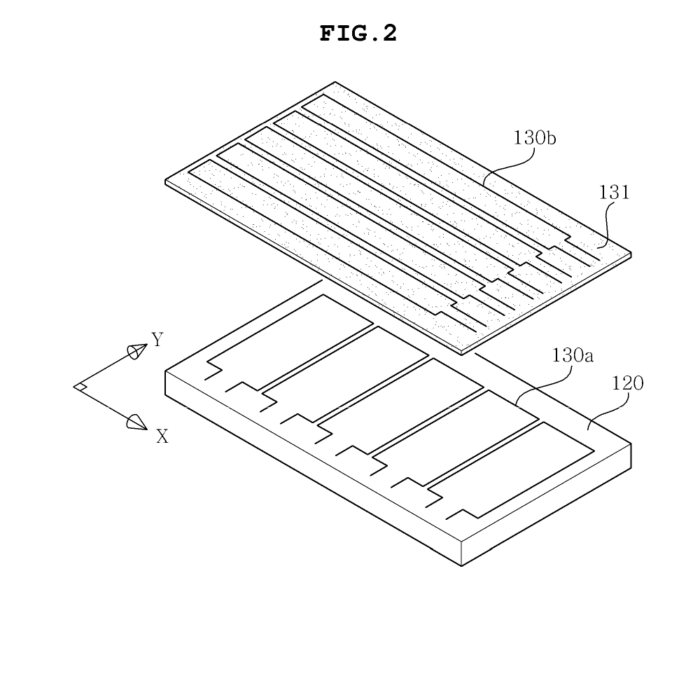

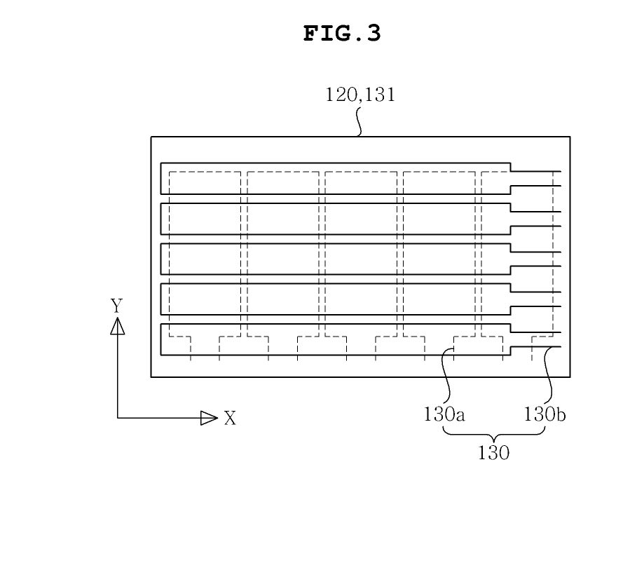

FIG. 1 is an exploded perspective view of a back light unit integrated digitizer according to a preferred embodiment of the present invention, FIG. 2 is an exploded perspective view of a cover illustrated in FIG. 1, and FIG. 3 is a plan view of a cover illustrated in FIG. 1.

As illustrated in FIGS. 1 to 3, a back light unit integrated digitizer 100 according to a preferred embodiment of the present invention is configured to include a cover 120 disposed on one surface of a back light unit 110 to protect the back light unit 110 and a loop coil 130 formed on the cover 120.

The back light unit 110 is disposed under a liquid crystal display (LCD) panel to supply light having uniform brightness in the LCD panel 160 direction. In detail, the back light unit 110 has a structure in which a reflector 113, a housing 115, a light guide 117, and a sheet material 119 are stacked in order. In this configuration, the housing 115 serves to accurately couple and support internal components such as the light guide 117 and the sheet material 119. Further, the light guide 117 receives light diffused from a light source using a transparent acrylic panel, and the like, to uniformly distribute light over the whole region through patterns formed on a surface thereof. In addition, the reflector 113 is coupled with the housing 115 by so as to be disposed under the light guide 117 and again reflects light emitted from the light guide 117 to the light guide 117. Meanwhile, the sheet material 119 includes a diffusion sheet 119a, a prism sheet 119b, and a protective sheet 119c. In this configuration, the diffusion sheet 119a is disposed over the light guide 117 to scatter the light emitted from the light guide 117 in a predetermined direction and uniformly diffuse the scattered light over the overall surface of the light guide 117. Further, the prism sheet 119b collects light emitted from the diffusion sheet 119a to increase brightness and the protective sheet 119c prevents a scratch from occurring on the prism sheet 119b and a moiré phenomenon from occurring.

The cover 120 is disposed under the back light unit 110 to protect the lower part of the back light unit 110 and may be formed of metal, but the preferred embodiments of the present invention is not limited thereto. Further, the cover 120 is provided with the loop coil 130 to sense an input unit 140 (a stylus pen, and the like) and the detailed description of the loop coil 130 will be described below.

Meanwhile, the other surface of the back light unit 110 (a surface opposite to one surface of the back light unit 110 on which the cover 120 is disposed) is provided with the LCD panel 160. In this configuration, the LCD panel 160 includes a liquid crystal module (LCM) 163 and polarizers 165 disposed on both surfaces of the LCM 163. In this case, two polarizers 165 disposed on both surfaces of the LCM 163 polarize the light incident from the back light unit 110 vertically to each other.

The loop coil 130 that is one component of the digitizer along with the input unit 140 is disposed on the cover 120. In this configuration, the input unit 140 may be, for example, an electromagnetic induction type stylus pen and the user instructs coordinates using the input unit 140. In detail, the input unit 140 includes a resonance circuit resonated at a specific frequency and the resonance circuit resonates with a signal of a specific frequency transmitted through the loop coil 130 to generate induced voltage. In addition, when a signal of a specific frequency transmitted through the loop coil 130 stops, the induced voltage generated by the resonance circuit generates an electromagnetic wave from a position detection coil configuring the resonance circuit. In this case, the input unit 140 transmits the electromagnetic wave generated from the coil of the resonance circuit to the loop coil 130, such that the loop coil 130 may finally recognize coordinates.

Meanwhile, the loop coil 130 may be formed in the back light unit 110 direction in both surfaces of the cover 120 so as not to be exposed to the outside. Herein, the loop coil 130 may include a plurality of first loop coils 130a disposed in parallel in a Y-axis direction and a plurality of second loop coils 130b disposed in parallel in an X-axis direction (see FIGS. 2 and 3). In this case, the first loop coil 130a and the second loop coil 130b may intersect vertically each other, and the first loop coil 130a is directly formed on one surface of the cover 120 and the second loop coil 130b may be directly formed on an insulating layer 131 disposed on one surface thereof. As described above, the loop coil 130 may be directly formed on the cover 120 of the back light unit 110 to integrally form the digitizer in the back light unit 110, thereby reducing the overall thickness to implement slimness and saving the manufacturing costs to secure price competitiveness.

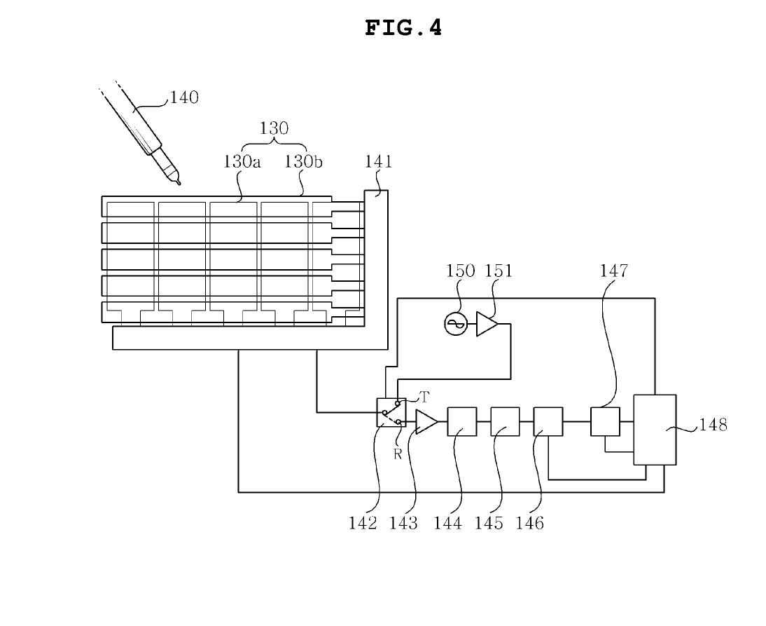

Further, FIG. 4 is a block diagram of a digitizer according to a preferred embodiment of the present invention and the digitizer will be described in more detail with reference to FIG. 4. As illustrated in FIG. 4, the plurality of first loop coils 130a and the plurality of second loop coils 130b are connected with a selection circuit 141 that selects any loop coil 130. Here, the selection circuit 141 is connected with a transmitting and receiving conversion circuit 142. A receiving terminal R of the transmitting and receiving conversion circuit 142 is connected to an amplifier 143, the amplifier 143 is connected to a detection circuit 144, the detection circuit 144 is connected to a sample and hold circuit 146 through a low-pass filter 145. In addition, the sample and hold circuit 146 is connected to an analog/digital conversion circuit 147 and the analog/digital conversion circuit 147 is connected to a central processing unit (CPU) 148. In this case, the CPU 148 supplies a control signal to the selection circuit 141, the sample and hold circuit 146, the analog/digital conversion circuit 147, and the transmitting and receiving conversion circuit 142, respectively.

Further, the digitizer includes an oscillator 150 that generates an AC signal of a frequency and a current driver 151 that converts an AC signal into current. Herein, the current driver 151 is connected to a transmitting terminal T of the transmitting and receiving conversion circuit 142. Therefore, when a contact of the transmitting and receiving conversion circuit 142 is switched to the transmitting side by the control signal supplied from the CPU 148, a magnetic field is generated from the loop coil 130.

When the transmitting and receiving conversion circuit 142 is connected to the transmitting terminal T, the resonance circuit embedded in the input unit 140 is resonates to generate the induced voltage as the input unit 140 approaches the loop coil 130. Next, when the terminal of the transmitting and receiving conversion circuit 142 is switched to the receiving terminal R according to the control signal supplied from the CPU 148, the magnetic field is not supplied to the input unit 140 from the loop coil 130 and the magnetic field is generated from a position detection coil embedded in the input unit 140. In this case, the loop coil 130 detects the magnetic field generated from the input unit 140. In detail, the coordinates instructed by the input unit 140 may be detected from the position of the loop coil 130 in which the magnetic field generated from the input unit 140 is strongest detected, among the loop coils 130 selected by the selection circuit 141.

However, the foregoing digitizer is only by way of example, and therefore the preferred embodiment of the present invention is not limited thereto, but all the types of electromagnetic induction type known to those skilled in the art may be applied.

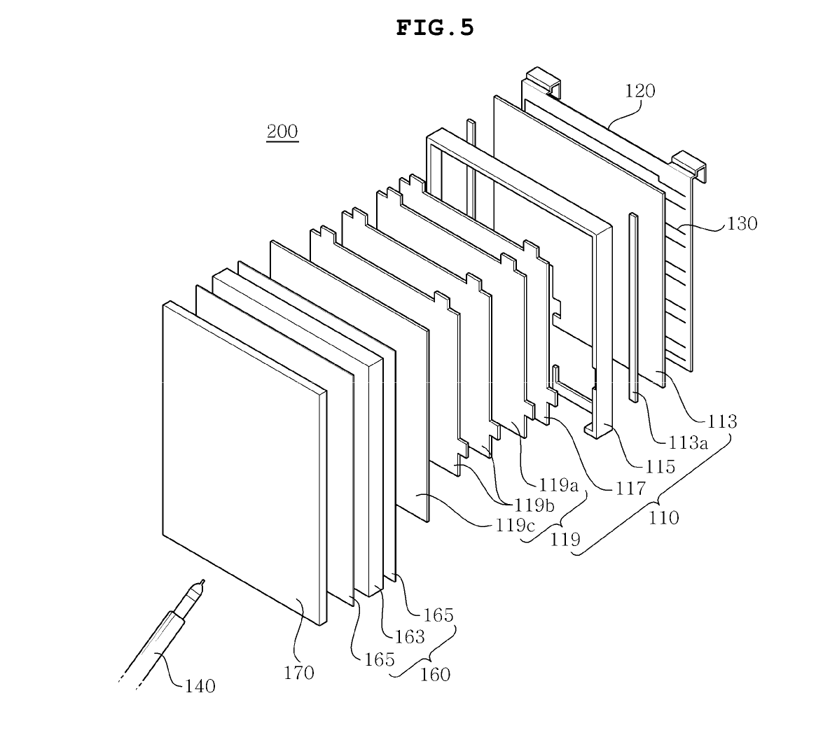

Meanwhile, FIG. 5 is an exploded perspective view of a back light unit integrated digitizer according to a modified example of the present invention. As illustrated in FIG. 5, a back light unit integrated digitizer 200 according to the modified example of the preferred embodiment of the present invention may include a touch panel 170 disposed over the LCD panel 160. Herein, the type of the touch panel 170 is not particularly limited, but may be a capacitive type touch panel, such as a self capacitive type touch panel, a mutual capacitive type touch panel, and the like. When the capacitive type touch panel is touched by a user, the capacitive type touch panel measures variations in capacitance to recognize touched coordinates. As such, the touch panel 170 is disposed over the LCD panel 160, such that the modified example of the preferred embodiment of the present invention may use the touch screen function along with the digitizer function.

According to the preferred embodiments of the present invention, the digitizer can be integrally formed in the backlight unit of the liquid crystal display, thereby reducing the overall thickness to implement the slimness and saving the manufacturing costs to secure the price competitiveness.

According to the preferred embodiments of the present invention, the touch panel can be disposed over the liquid crystal display, thereby using the function of the touch screen while using the function of the digitizer.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A back light unit integrated digitizer, comprising:
a cover disposed on one surface of the back light unit to protect the back light unit; and
a loop coil formed on the cover.

2. The back light unit integrated digitizer as set forth in claim 1, wherein the loop coil is formed in the back light unit direction in both surfaces of the cover.

3. The back light unit integrated digitizer as set forth in claim 2, wherein the loop coil includes:
a first loop coil formed on one surface of the cover; and
a second loop coil formed on an insulating layer disposed on one surface of the cover.

4. The back light unit integrated digitizer as set forth in claim 3, wherein the first loop coil and the second loop coil intersect vertically to each other.

5. The back light unit integrated digitizer as set forth in claim 1, wherein in the back light unit, a reflector, a housing, a light guide, and a sheet material are stacked in order, and the cover is disposed under the reflector.

6. The back light unit integrated digitizer as set forth in claim 5, wherein the sheet material includes a diffusion sheet, a prism sheet, and a protective sheet.

7. The back light unit integrated digitizer as set forth in claim 1, wherein the other surface of the back light unit is provided with a LCD panel.

8. The back light unit integrated digitizer as set forth in claim 7, wherein the LCD panel includes a liquid crystal module (LCM) and polarizers disposed on both sides of the LCM.

9. The back light unit integrated digitizer as set forth in claim 7, wherein a touch panel is disposed over the LCD panel.

10. The back light unit integrated digitizer as set forth in claim 9, wherein the touch panel is a capacitive type touch panel.
